(19) United States
(12) Patent Application Publication
(10) Pub. No.: US 2014/0024766 A1
(43) Pub. Date: Jan. 23, 2014

(54) COPOLYMERS OF 1,2-DIACETOXYETHYLENE AND VINYL ACETATE, PROCESS OF MAKING THE COPOLYMERS AND PROCESS OF MAKING A COPOLYMERIZED POLYVINYL ALCOHOL

(71) Applicants: Joseph G. Duff, League City, TX (US); Stephen Kerlegon, League City, TX (US); Kien-Van Phung, Pearland, TX (US); Daniel Rangel-Osalde, League City, TX (US); Tatiana H. Sonnenberg, Houston, TX (US); Cathy Tway, Shepherd, MI (US); Hang Wang, Houston, TX (US)

(72) Inventors: Joseph G. Duff, League City, TX (US); Stephen Kerlegon, League City, TX (US); Kien-Van Phung, Pearland, TX (US); Daniel Rangel-Osalde, League City, TX (US); Tatiana H. Sonnenberg, Houston, TX (US); Cathy Tway, Shepherd, MI (US); Hang Wang, Houston, TX (US)

(73) Assignee: Celanese International Corporation, Irving, TX (US)

(21) Appl. No.: 13/554,599

(22) Filed: Jul. 20, 2012

(51) Int. Cl. C08F 216/06; C08L 29/04; C08F 8/00

(52) U.S. Cl. 524/557; 525/60

(57) ABSTRACT

In one embodiment, the invention is to a vinyl acetate/diacetoxyethylene copolymer, processes of making the copolymer and processes of hydrolyzing said copolymer to form a copolymerized polyvinyl alcohol.

### FIELD OF THE INVENTION

This invention relates to processes for producing a vinyl acetate copolymer and, in particular, to processes of making a copolymerized polyvinyl alcohol from said vinyl acetate copolymers.

### BACKGROUND OF THE INVENTION

Vinyl acetate is an important monomer in the production of polyvinyl acetate and polyvinyl alcohol products. Polyvinyl acetate homopolymer has conventionally been prepared by self polymerizing vinyl acetate monomer in the presence of one or more polymerization initiators, by a variety of methods, such as those described in U.S. Pat. Nos. 3,943,103; 3,983,096 and 6,001,916. Conventionally, polyvinyl alcohol (PVOH) is prepared by hydrolyzing polyvinyl acetate homopolymer in an alcohol with base in a continuous process, such that the acetate groups are hydrolyzed by ester interchange with methanol in the presence of anhydrous sodium methylate or aqueous sodium hydroxide. The polyvinyl alcohol formed by these methods is almost entirely comprised of repeating 1,3-diol units.

Polyvinyl alcohol finds extensive use in the form of packaging films for packaging unit doses of various chemicals or agents, typically agrochemicals, in sealed, water-soluble PVOH film containers. When such unit dose packages are contacted with water, the PVOH film dissolves and the contents are dissolved or dispersed in water to produce the intended effects.

Unmodified, partially hydrolyzed PVOH films with a degree of hydrolysis of about 88 percent have been used as water-soluble films for such unit dose packaging. These water-soluble films are readily soluble in cold or warm water and have excellent mechanical strength. However, such PVOH films are disadvantageous in that they lack stiffness, emit the odor of acetic acid, and, when they are used for packaging alkaline substances, water solubility is reduced. One proposed reason for the lack of stiffness is that the degree of hydrolysis of the unmodified partially hydrolyzed PVOH is low and the water content of films thereof increases accordingly.

U.S. Pat. No. 6,608,121 discloses a water-soluble resin composition which comprises (i) 100 parts by weight of a polyvinyl alcohol polymer having a 1,2-glycol linkage content of at least 1.8 mole percent and a degree of hydrolysis of at least 90 mole percent, (ii) 1 to 50 parts by weight of a plasticizer and (iii) 5 to 50 parts by weight of a monosaccharide and/or a polysaccharide, optionally together with (iv) 1 to 20 parts by weight of an inorganic filler. Also provided is a water-soluble resin composition which comprises (i′) 100 parts by weight of a polyvinyl alcohol polymer having a 1,2-glycol linkage content of at least 1.8 mole percent and a degree of hydrolysis of 92 to 99 mole percent, (ii′) 1 to 50 parts by weight of a plasticizer and (iv′) 1 to 20 parts by weight of an inorganic filler, optionally together with (iii′) 5 to 50 parts by weight of a monosaccharide and/or polysaccharide. Further provided are water-soluble films produced by using those water-soluble resin compositions. The resins and films are disclosed to have improved water solubility and biodegradeability, and formation of the 1,2-glycol linkages is accomplished by either by addition of no more than 5 mole % of various comonomers, so as to avoid decreased biodegradeability, or by homopolymerization of vinyl acetate under relatively severe temperature (120-180° C.) and pressure conditions (0.4 to 1.2 MPa).

Thus, the need exists for improved processes for producing polyvinyl acetate under less severe conditions of temperature and pressure and without causing decreased biodegradeability in the resultant product. The polyvinyl acetate, when hydrolyzed into polyvinyl alcohol may contain a significant amount of 1,2-diol units.

The references mentioned above are hereby incorporated by reference.

### SUMMARY OF THE INVENTION

The present invention, in one embodiment, is to a process for producing polyvinyl alcohol, the process comprising the steps of: (a) contacting diacetoxyethylene(s) and vinyl acetate to form a vinyl acetate copolymer; and (b) hydrolyzing the vinyl acetate copolymer to form a co-polymerized polyvinyl alcohol.

In another embodiment, the invention is to a vinyl acetate/diacetoxyethylene copolymer.

In another embodiment, the invention is to a process for producing a vinyl acetate copolymer, comprising: contacting vinyl acetate and diacetoxyethylene(s) in the presence of a polymerization initiator.

In another embodiment, the invention is to a polyvinyl alcohol comprising at least 5 mole % of 1,2-diol units, such as at least 5 mole % and up to 99 mole % of 1,2-diol units.

In another embodiment, the invention is to a polyvinyl alcohol composition comprising polyvinyl alcohol having at least 5 mole % of 1,2-diol units, and one or more additives selected from the group consisting of plasticizers, fillers, colorants, perfumes, extenders, antifoaming agents, release agents, ultraviolet absorbers and surfactants.

### DETAILED DESCRIPTION OF THE INVENTION

It has been discovered that copolymerizing vinyl acetate monomer with diacetoxyethylenes forms unique vinyl acetate copolymers, which when hydrolyzed into polyvinyl alcohol, contain 1,2-diol units in an almost unlimited amount. Beneficially biodegradeability of the products is not negatively affected. Advantageously, the copolymerization conditions are relatively mild as compared to the prior art.

The diacetoxyethylene comonomers may comprise trans- and cis-diacetoxyethylene having the following structural formulae:

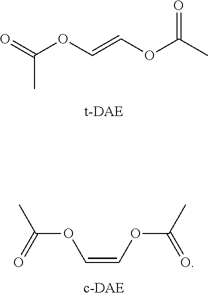

When incorporated into polyvinyl acetate as units, these comonomers, surprisingly provide pendant acetate groups in a 1,2-linkage configuration, which are readily hydrolyzed when forming polyvinyl alcohol. The polyvinyl acetate units do not modify the backbone polymer chain composition as a conventional monomer might.

Polyvinyl alcohol usually has about 1.2-1.4 mole % of 1,2-diol units, which is caused by head-to-head polymerization of vinyl acetate monomer. The remainder of the diol units are 1,3-diol units formed by head-to-tail polymerization of vinyl acetate monomer. These higher levels of 1,2-diol units will give the resultant polyvinyl alcohol unique properties, such as (1) more solution stability, e.g., less tendency of gelling, especially when fully hydrolyzed; (2) better biodegradeability, since degradation occurs at the 1,2-diol linkages; (3) the ability to act as a better protective colloid in other polymerization processes, due to the increased solution stability; and (4) easier melt processing, due to decreased crystallinity.

### Diacetoxyethylene Formation

Advantageously, diacetoxyethylenes useful in the present invention may be obtained as a by-product in the formation of vinyl acetate monomer. The amount of such diacetoxyethylenes so-formed can be increased, and the diacetoxyethylenes sufficiently purified as set forth in co-assigned U.S. patent application Ser. No. 13/327,401, filed Dec. 15, 2011.

For example, it has been found that the addition of vinyl acetate, e.g., vinyl acetate monomer (VAM), directly or indirectly, to a vinyl acetate reactor results in a crude vinyl acetate composition, e.g., a reactor effluent stream, comprising higher amounts of diacetoxyethylenes. The additional vinyl acetate may be fresh vinyl acetate and/or vinyl acetate that is recycled from another point in the process. The process includes contacting a vinyl acetate stream with acetic acid, ethylene, and oxygen (pure or in a mixture, e.g., air), to form a reaction mixture. The additional vinyl acetate may be added to at least one of the reactant feed streams and/or directly into a vinyl acetate reactor. Preferably, the vinyl acetate is added upstream of the reactor. As a result, a crude vinyl acetate composition exiting the reaction comprises vinyl acetate and an increased concentration of diacetoxyethylenes. For example, the crude vinyl acetate composition comprises at least 0.1 wt % diacetoxyethylenes, e.g., at least 0.2 wt %, or at least 0.3 wt %, or at least 0.4 wt %, or at least 0.5 wt %, or even at least 1 wt %. In terms of ranges, the crude vinyl acetate composition may comprise diacetoxyethylenes in amounts ranging from about 0.1 wt % to 1.0 wt %, e.g., from 0.2 wt % to 0.5 wt %, or from 0.3 wt % to 0.4 wt %.

The crude vinyl acetate composition may be further processed to separate the components thereof to form a purified vinyl acetate stream and at least one by-product stream. The purified vinyl acetate stream comprises vinyl acetate and reduced amounts of by-products, as compared to the crude vinyl acetate composition. At least one of the by-product streams comprises at least a portion of the diacetoxythylene that was initially present in the crude product stream. As a result of the additional vinyl acetate to the reaction mixture, the by-product stream(s) comprise higher amounts of diacetoxyethylene, e.g., at least 4.6 wt % diacetoxyethylene, at least 5 wt % or at least 10 wt %. In terms of ranges, the by-product stream(s) may comprise from 4.6 wt % to 16 wt % diacetoxyethylene. e.g., from 5 wt % to 15 wt %.

The separated diacetoxyethylene can be recovered for use according to the present invention. In one embodiment, the recovered by-product stream comprises at least 1 wt % of the diacetoxyethylene that was initially present in the crude vinyl acetate stream, e.g., at least 5 wt % or at least 10 wt %. When higher amounts of diacetoxyethylene are present in the crude vinyl acetate mixture, separation efficiencies are improved and higher amounts of the diacetoxyethylene are separated and recovered. Any suitable separation techniques may be employed to perform the separation. Examples include single or multiple distillations of the crude effluent stream, sometimes followed by adsorption techniques, precipitation techniques, or crystallization techniques, depending on the purity of diacetoxyethylenes desired.

### Vinyl Acetate Formation

Conventionally, formation of vinyl acetate may be carried out by reacting acetic acid and ethylene in the presence of oxygen. In other embodiments, the features of the present invention may apply to production of other monomers such as, for example, vinyl esters, or diacetoxyethylene. This reaction may take place heterogeneously with the reactants being present in the gas phase. The reactor may be configured such that the reactor is capable of removing heat from the reaction. Suitable reactor types include, but are not limited to, a fixed bed reactor and a fluidized bed reactor. Preferably, the molar ratio of ethylene to acetic acid in the reaction ranges from 1:1 to 10:1, e.g., from 1:1 to 5:1; or from 2:1 to 3:1. In one embodiment, the molar ratio of ethylene to oxygen in the reaction ranges from 1:1 to 20:1, e.g., from 1.5:1 to 10:1; or from 2:1 to 5:1. In another embodiment, the molar ratio of acetic acid to oxygen in the reaction ranges from 1:1 to 10:1, e.g., from 1:1 to 5:1; or from 1:1 to 3:1.

The acetic acid may be produced by any suitable method. As one example, the acetic acid may be produced via methanol carbonylation with carbon monoxide. Water may be formed in situ in a liquid reaction composition, for example, by the esterification reaction between the methanol reactant and the acetic acid product. In one embodiment, water is introduced to the carbonylation reactor together with or separately from other components of the liquid reaction composition. Water may be separated from other components of reaction composition, withdrawn from the reactor, and may be recycled in controlled amounts to maintain the required concentration of water in the liquid reaction composition. Preferably, the concentration of water maintained in the liquid reaction composition is in the range of from 0.1 wt. % to 16 wt. %, e.g., from 1 wt. % to 14 wt. %, or from 1 wt. % to 10 wt. %.

In another embodiment, the carbonylation reaction is a low water carbonylation, wherein the concentration of water maintained in the liquid reaction composition ranges from 0.1 wt. % to 14 wt. %, e.g., from 1 wt. % to 10 wt. %. The low water carbonylation may be conducted by maintaining in the reaction medium an ester of the desired carboxylic acid and an alcohol, desirably the alcohol used in the carbonylation, and an additional iodide ion that is over and above the iodide ion that is present as hydrogen iodide. An example of a preferred ester is methyl acetate. The additional iodide ion is desirably an iodide salt, with lithium iodide (LiI) being preferred. It has been found, as described in U.S. Pat. No. 5,001,259, that under low water concentrations, methyl acetate and lithium iodide act as rate promoters only when relatively high concentrations of each of these components are present and that the promotion is higher when both of these components are present simultaneously. The disclosure of U.S. Pat. No. 5,001,259 is hereby incorporated by reference. The concentration of iodide ion maintained in the reaction medium of the preferred carbonylation reaction system is believed to be quite high as compared with what little prior art there is dealing with the use of halide salts in reaction systems of this sort. The absolute concentration of iodide ion content is not a limitation on the usefulness of the present invention.

In other embodiments, the acetic acid may be derived from natural gas, petroleum, coal, biomass, and so forth. As examples, acetic acid may be produced via acetaldehyde oxidation, ethylene oxidation, oxidative fermentation, and anaerobic fermentation.

As petroleum and natural gas prices fluctuate, becoming either more or less expensive, methods for producing acetic acid and intermediates such as methanol and carbon monoxide from alternate carbon sources have drawn increasing interest. In particular, when petroleum is relatively expensive compared to natural gas, it may become advantageous to produce acetic acid from synthesis gas (“syngas”) that is derived from any available carbon source. U.S. Pat. No. 6,632,752, which is hereby incorporated by reference, for example, teaches a method of retrofitting a methanol plant for the manufacture of acetic acid. By retrofitting a methanol plant, the large capital costs associated with carbon monoxide generation for a new acetic acid plant are significantly reduced or largely eliminated. All or part of the syngas is diverted from the methanol synthesis loop and supplied to a separator unit to recover carbon monoxide and hydrogen, which are then used to produce acetic acid.

In some embodiments, at least some of the raw materials may be derived partially or entirely from syngas. For example, the acetic acid may be formed from methanol and carbon monoxide, both of which may be derived from syngas. For example, the methanol may be formed by steam reforming syngas, and the carbon monoxide may be separated from syngas. In other embodiments, the methanol may be formed in a carbon monoxide unit, e.g., as described in EP2076480; EP1927380; EP2072490; EP1914219; EP1904426; EP2072487; E02072492; EP2072486; EP2060553; EP1741692; EP1907744; EP2060555; EP2186787; EP2072488; and U.S. Pat. No. 7,842,844, which are hereby incorporated by reference. Of course, this listing of methanol sources is merely exemplary and is not meant to be limiting. In addition, the above-identified methanol sources, inter alia, may be used to form the formaldehyde, e.g., in situ, which, in turn may be reacted with the acetic acid to form the acrylic acid. The syngas, in turn, may be derived from variety of carbon sources. The carbon source, for example, may be selected from the group consisting of natural gas, oil, petroleum, coal, biomass, and combinations thereof. Syngas or hydrogen may also be obtained from bio-derived methane gas, such as bio-derived methane gas produced by landfills or agricultural waste.

In another embodiment, in addition to the acetic acid formed via methanol carbonylation, some additional acetic acid may be formed from the fermentation of biomass and may be used in the hydrogenation step. The fermentation process preferably utilizes an acetogenic process or a homoacetogenic microorganism to ferment sugars to acetic acid producing little, if any, carbon dioxide as a by-product. The carbon efficiency for the fermentation process preferably is greater than 70%, greater than 80% or greater than 90% as compared to conventional yeast processing, which typically has a carbon efficiency of about 67%. Optionally, the microorganism employed in the fermentation process is of a genus selected from the group consisting of Clostridium, Lactobacillus, Moorella, Thermoanaerobacter, Propionibacterium, Propionispera, Anaerobiospirillum, and Bacteriodes, and in particular, species selected from the group consisting of Clostridium formicoaceticum, Clostridium butyricum, Moorella thermoacetica, Thermoanaerobacter kivui, Lactobacillus delbrukii, Propionibacterium acidipropionici, Propionispera arboris, Anaerobiospirillum succinicproducens, Bacteriodes amylophilus and Bacteriodes ruminicola. Optionally in this process, all or a portion of the unfermented residue from the biomass, e.g., lignans, may be gasified to form hydrogen that may be used in the hydrogenation step of the present invention. Exemplary fermentation processes for forming acetic acid are disclosed in U.S. Pat. Nos. 6,509,180; 6,927,048; 7,074,603; 7,507,562; 7,351,559; 7,601,865; 7,682,812; and 7,888,082, the entireties of which are incorporated herein by reference. See also U.S. Pub. Nos. 2008/0193989 and 2009/0281754, the entireties of which are incorporated herein by reference.

Examples of biomass include, but are not limited to, agricultural wastes, forest products, grasses, and other cellulosic material, timber harvesting residues, softwood chips, hardwood chips, tree branches, tree stumps, leaves, bark, sawdust, off-spec paper pulp, corn, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, plastic, and cloth. See, e.g., U.S. Pat. No. 7,884,253, the entirety of which is incorporated herein by reference. Another biomass source is black liquor, a thick, dark liquid that is a byproduct of the Kraft process for transforming wood into pulp, which is then dried to make paper. Black liquor is an aqueous solution of lignin residues, hemicellulose, and inorganic chemicals.

Methanol carbonylation processes suitable for production of acetic acid are described in U.S. Pat. Nos. 7,208,624, 7,115,772, 7,005,541, 6,657,078, 6,627,770, 6,143,930, 5,599,976, 5,144,068, 5,026,908, 5,001,259, and 4,994,608, all of which are hereby incorporated by reference.

U.S. Pat. No. RE 35,377, which is hereby incorporated by reference, provides a method for the production of methanol by conversion of carbonaceous materials such as oil, coal, natural gas and biomass materials. The process includes hydrogasification of solid and/or liquid carbonaceous materials to obtain a process gas which is steam pyrolized with additional natural gas to form syn gas. The syn gas is converted to methanol which may be carbonylated to acetic acid. U.S. Pat. No. 5,821,111, which discloses a process for converting waste biomass through gasification into syn gas, as well as U.S. Pat. No. 6,685,754 are hereby incorporated by reference.

In one optional embodiment, the acetic acid that is utilized comprises acetic acid and may also comprise other carboxylic acids, e.g., propionic acid, esters, and anhydrides, as well as acetaldehyde and acetone. In one embodiment, the acetic acid fed to the condensation reaction comprises propionic acid. For example, the acetic acid fed to the reaction may comprise from 0.001 wt % to 15 wt % propionic acid, e.g., from 0.001 wt % to 0.11 wt %, from 0.125 wt % to 12.5 wt %, from 1.25 wt % to 11.25 wt %, or from 3.75 wt % to 8.75 wt %. Thus, the acetic acid feed stream may be a cruder acetic acid feed stream, e.g., a less-refined acetic acid feed stream.

The ethylene similarly may be produced by any suitable method. In one embodiment, the ethylene is formed via the hydrogenation of acetic acid followed by the dehydration of the acetic acid to form ethylene. As another alternative, the acetic acid and the ethylene may be produced via oxidation of an alkane, e.g., ethane, as discussed in U.S. Pat. No. 6,476,261, the disclosure of which is hereby incorporated by reference. The oxygen used in the formation of vinyl acetate in the method of the present invention may further comprise other inert gases such as nitrogen. As one example, the oxygen used in the vinyl acetate reaction is provided by an air stream.

In one embodiment, additional ethylene may be fed to the reactor. This additional ethylene, as well as the reactant ethylene mentioned above, may be substantially pure. In one embodiment, the ethylene may be admixed, for example, with one or more of nitrogen, methane, carbon dioxide, carbon monoxide, hydrogen, and low levels of C₃/C₄ alkenes/alkanes. Additional oxygen may be fed to the reactor. The additional oxygen, if used, may be air or a gas richer or poorer in molecular oxygen than air. One suitable additional molecular oxygen-containing gas may be, oxygen diluted with a suitable diluent, for example nitrogen or carbon dioxide. Preferably, the additional molecular oxygen-containing gas is oxygen. Preferably, at least some of the oxygen is fed to the reactor independently from the ethylene and acetic acid.

The vinyl acetate reaction may suitably be carried out at a temperature in the range of from 100° C. to 300° C., e.g., from 140° C. to 220° C. or from 150° C. to 200° C. In another embodiment, the reaction may be carried out pressure in the range of from 0.1 MPa to 10 MPa, e.g., from 0.1 MPa to 2.5 MPa or from 1 MPa to 2.5 MPa.

Preferably, the vinyl acetate formation reaction is conducted over a catalyst and the catalyst may vary widely. For example, suitable catalysts include catalysts comprising a first metal and optionally one or more of a second metal, a third metal, or additional metals. The catalyst optionally comprises a catalyst support. The first and optional second and third metals may be selected from palladium, gold, boron, alkali metals, and Group IB or VIIIB transition metals.

The first metal optionally is present in an amount from 0.1 to 10 wt. %, e.g., from 0.2 to 5 wt. %, or from 0.2 to 2.5 wt. %. The additional metals, if present, may be present in amounts ranging from 0.1 to 10 wt. %, e.g., from 0.2 to 5 wt. %, or from 0.2 to 2.5 wt. %. In other embodiments, the catalyst may comprise metalloids, e.g., boron, in amounts ranging from 0.01 wt. % to 1 wt. %, e.g., from 0.01 wt. % to 0.2 wt. %. For catalysts comprising two or more metals, the two or more metals may be alloyed with one another. Alternatively, the two or more metals may comprise a non-alloyed metal solution or mixture. Also, the preferred metal ratios may vary depending on the metals used in the catalyst. If palladium and gold are utilized, the ratio may range from 0.5:1 to 20:1, e.g., from 1.8:1 to 10:1. In some exemplary embodiments where a first and second metal are used, the mole ratio of the first metal to the second metal is from 5:1 to 1:1, e.g., from 3:1 to 1:1, or from 2:1 to 1:1.

In addition to one or more metals, the exemplary catalysts further comprise a support or a modified support, meaning a support that includes a support material and a support modifier, which adjusts the acidity of the support material. The total weight of the support or modified support, based on the total weight of the catalyst, preferably is from 75 wt. % to 99.9 wt. %, e.g., from 78 wt. % to 97 wt. %, or from 80 wt. % to 95 wt. %. In preferred embodiments that use a modified support, the support modifier is present in an amount from 0.1 wt. % to 50 wt. %, e.g., from 0.2 wt. % to 25 wt. %, from 0.5 wt. % to 15 wt. %, from 1 wt. % to 8 wt. %, from 1 wt. % to 5 wt. %, or from 2 wt. % to 4 wt. %, based on the total weight of the catalyst.

Suitable support materials may include silica, alumina, silica-alumina, titania, ticano-silicates, zirconia, zircono-silicate, niobia, silicates, alumino-silicates, titanates, carbon, metals, and glasses. Preferred supports include zirconia, zircono-silicates, and titano-silicates. Suitable support modifiers may include barium, magnesium, cerium, potassium, calcium, niobium, tantalum, titanium, yttrium, strontium, zirconium, vanadium, molybdenum, and rubidium. Preferred support modifiers include niobium, titanium, magnesium, and zirconium.

Specific examples of suitable catalysts include, for example, those described in GB 1 559 5401; EP 0 330 853; EP 0 672 4563; U.S. Pat. Nos. 5,185,308; 5,691,267; 6,114,571; 6,852,877; and 6,603,038. The disclosures of all of the above-mentioned references are hereby incorporated by reference.

GB 1 559 540 describes suitable catalysts that can be employed in the preparation of vinyl acetate by the reaction of ethylene, acetic acid and oxygen. The catalysts are comprised of: (1) a catalyst support having a particle diameter of from 3 to 7 mm and a pore volume of from about 0.2 to 1.5 ml per gram, a 10% by weight water suspension of the catalyst support having a pH from about 3.0 to 9.0, (2) a palladium-gold alloy distributed in a surface layer of the catalyst support, the surface layer extending less than 0.5 mm from the surface of the support, the palladium in the alloy being present in an amount of from about 1.5 to 5.0 grams per liter of catalyst, and the gold being present in an amount of from about 0.5 to 2.25 grams per liter of catalyst, and (3) from 5 to 60 grams per liter of catalyst of alkali metal acetate.

U.S. Pat. No. 5,185,308 describes a shell impregnated catalyst active for the production of vinyl acetate from ethylene, acetic acid, and an oxygen-containing gas, the catalyst consisting essentially of (1) a catalyst support having a particle diameter from about 3 to about 7 mm and a pore volume of 0.2 to 1.5 ml per gram, (2) palladium and gold distributed in the outermost 1.0 mm thick layer of the catalyst support particles, and (3) from about 3.5 to about 9.5% by weight of potassium acetate wherein the gold to palladium weight ratio in said catalyst is in the range 0.6 to 1.25.

U.S. Pat. No. 5,691,267 describes a two step gold addition method for a catalyst used in the gas phase formation of vinyl acetate from the reaction of ethylene, oxygen, and acetic acid. The catalyst is formed by (1) impregnating a catalyst carrier with aqueous solutions of a water-soluble palladium salt and a first amount of a water-soluble gold compound such as sodium-palladium chloride and auric chloride, (2) fixing the precious metals on the carrier by precipitating the water-insoluble palladium and gold compounds by treatment of the impregnated carriers with a reactive basic solution such as aqueous sodium hydroxide which reacts with the palladium and gold compounds to form hydroxides of palladium and gold on the carrier surface, (3) washing with water to remove the chloride ion (or other anion), and (4) reducing all the precious metal hydroxides to free palladium and gold, wherein the improvement comprises (5) impregnating the carrier with a second amount of a water-soluble gold compound subsequent to fixing a first amount of water-soluble gold agent, and (6) fixing the second amount of a water-soluble gold compound.

U.S. Pat. No. 6,114,571 describes a catalyst for forming vinyl acetate in the gas phase from ethylene, acetic acid, and oxygen or oxygen-containing gases wherein the catalyst is comprised of palladium, gold, boron, and alkali metal compounds on a support. The catalyst is prepared by a) impregnating the support with soluble palladium and gold compounds; b) converting the soluble palladium and gold compounds on the support into insoluble compounds by means of an alkaline solution; c) reducing the insoluble palladium and gold compounds on the support by means of a reducing agent in the liquid phase; d) washing and subsequently drying the support; e) impregnating the support with a soluble alkali metal compound; and f) finally drying the support at a maximum of 1500° C., wherein boron or boron compounds are applied to the catalyst prior to the final drying.

U.S. Pat. No. 6,603,038 describes a method for producing catalysts containing metal nanoparticles on a porous support, especially for gas phase oxidation of ethylene and acetic acid to form vinyl acetate. The invention relates to a method for producing a catalyst containing one or several metals from the group of metals comprising the sub-groups Ib and VIIIb of the periodic table on porous support particles, characterized by a first step in which one or several precursors from the group of compounds of metals from sub-groups Ib and VIIIb of the periodic table is or are applied to a porous support, and a second step in which the porous, preferably nanoporous support to which at least one precursor has been applied is treated with at least one reduction agent, to obtain the metal nanoparticles produced in situ in the pores of said support.

EP 0 672 453 describes palladium-containing catalysts and their preparation for fluid bed vinyl acetate processes.

An advantage of using a palladium-containing catalyst is that any carbon monoxide produced in a prior reaction zone will be consumed in the presence of oxygen and the palladium-containing catalyst in the second reaction zone. An example of a prior reaction zone is a reaction zone for preparing the reactants. This eliminates the need for a separate carbon monoxide removal reactor.

The vinyl acetate reaction may be characterized in terms of conversions based on the reactants. In one embodiment, acetic acid conversions range from 1% to 100%, e.g., from 5% to 50% or from 10% to 45%. Oxygen conversions may range from 1% to 100%, e.g., from 20% to 100% or from 20% to 50%. Ethylene conversions may range from 1% to 90%, e.g., from 5% to 100% or from 10% to 50%. However, conversion of ethylene into diacetoxyethylenes or other by-products should be limited to be less than 5%, preferably less than 1%. That is, the process is advantageously conducted such that ethylene conversion into vinyl acetate is not diminished, as compared to a conventional vinyl acetate production process. In one embodiment, vinyl acetate selectivity, based on ethylene may range from 20% to 100%, e.g., from 50% to 95% or from 75% to 90%.

In conventional processes, higher product yields, e.g., vinyl acetate yields and/or higher diacetoxyethylene yields, could, in theory, be achieved by increasing ethylene and/or acetic acid conversions. Increasing these conversions, however, would inevitably reduce the amount of oxygen available for diacetoxyethylene production. Advantageously, the addition of vinyl acetate to the reaction, in accordance with the present invention, provides for higher overall vinyl acetate and/or diacetoxyethylene yields without increasing ethylene and/or acetic acid conversions. In one embodiment, the vinyl acetate formation reaction has an ethylene conversion less than 5% and the crude vinyl acetate composition comprises diacetoxyethylene in the inventive amounts.

In the vinyl acetate reaction, the catalyst may have a productivity (measured in space time yield, STY) ranging from 10 g/hr-liter to 5,000 g/hr-liter, e.g., from 100 g/hr-liter to 2,000 g/hr-liter or from 200 g/hr-liter to 1,000 g/hr-liter, where g/hr-liter means grams of vinyl acetate per hour per liter of catalyst. In terms of upper limits, the space time yield maybe less than 20,000 g/hr-liter, e.g., less than 10,000 g/hr-liter or less than 5,000 g/hr-liter.

### Polyvinyl Ester Copolymer Formation

In one embodiment, the invention is directed to a process for producing a novel vinyl acetate copolymer and the resulting copolymer. The process comprises the step of contacting vinyl acetate and diacetoxyethylene(s), optionally in the presence of a polymerization initiator. In one embodiment, the reaction is conducted at a temperature from 60° C. to 100° C., e.g., from 70° C. to 90° C. In one embodiment, the reaction is conducted at a pressure from atmospheric pressure to 0.8 MPa, e.g., from atmospheric to 0.4 MPa. Preferably, the process is conducted at atmospheric pressure and at a temperature below 100° C., since the process is conducted in a water solvent. The mole ratio of diacetoxyethylene(s) to vinyl acetate can be from 0.0005:1 to 1:0.0005, such as from 0.01:1 to 0.05:1. The diacetoxyethylene(s) can be in the form of an isomeric mixture of trans-diacetoxyethylene and cis-diacetoxyethylene, such as wherein the molar ratio of trans-diacetoxyethylene to cis-diacetoxyethylene is from 1:1 to 4:1, e.g., from 1:1 to 3:1. As stated above, the process acts to incorporate diacetoxyethylene units into the vinyl acetate polymer chain, creating pendant 1,2-acetate functionalities, which are easily hydrolyzed into 1,2-diol units.

The polyvinyl ester copolymer can be produced by any of the methods known in the art, for example by the solution polymerization, bulk polymerization, suspension polymerization or emulsion polymerization technique. The polymerization initiator, when employed, can appropriately be selected according to the method of polymerization. Examples include azo catalysts, peroxide catalysts, redox catalyst systems and combinations thereof.

The manner of combining the several polymerization ingredients, e.g., emulsifiers, co-monomers, catalyst system components, etc., can vary widely. Generally an aqueous medium containing at least some of the emulsifier(s), if used, can be initially formed in a polymerization vessel with the various other polymerization ingredients being added to the vessel thereafter.

Co-monomers can be added to the polymerization vessel continuously, incrementally, or as a single charge addition of the entire amounts of the co-monomers to be used. Co-monomers can be employed as pure monomers or can be used in the form of a pre-mixed emulsion.

The azo initiator may include 2,2′-azobisisobutyronitrile, 2,2′-azobis(2,4-dimethylvaleronitrile), and 2,2′-azobis(4-methoxy-2,4-dimethylvaleronitrile), and the peroxide initiator may include percarbonate compounds, such as diisopropyl peroxydicarbonate, di-2-ethylhexyl peroxydicarbonate, and diethoxyethyl peroxydicarbonate; perester compounds, such as t-butylperoxy neodecanoate, α-cumylperoxy neodecanoate, and t-butylperoxy decanoate; acetylcyclohexylsulfonyl peroxide; and 2,4,4-trimethylpentyl-2-peroxyphenoxyacetate. Further, it is also possible to make the initiator by combining potassium persulfate, ammonium persulfate, hydrogen peroxide, and the like with the initiators mentioned above. The redox initiator may include combinations of the peroxides mentioned above with a reducing agent, such as sodium hydrogen sulfite, sodium hydrogen carbonate, tartaric acid, L-ascorbic acid, and rongalite.

In some embodiments, upon copolymerization of the vinyl ester-based monomer and the diacetoxyethylene monomer, a chain transfer agent may be employed for the purposes of adjusting the degree of polymerization of the copolymer to be obtained and the like without impairment of the spirit of the present invention. The chain transfer agent may include aldehydes, such as acetaldehyde and propionaldehyde; ketones, such as acetone and methylethylketone; mercaptans, such as 2-hydroxyethanethiol; hydrocarbon halides, such as trichloroethylene and perchloroethylene; and phosphinates, such as sodium phosphinate monohydrate, and among all, aldehydes and ketones are used preferably. Although the amount of the chain transfer agent that is employed may be determined depending on the chain transfer constant of the chain transfer agent to be added and the degree of polymerization of the intended vinyl ester-based polymer, the amount may generally range from 0.1 to 10 wt % in terms of the vinyl ester-based monomer in general, e.g., from 1 wt % to 9 wt %.

As noted, the entire amount of the aqueous medium with the polymerization additives can be present in the polymerization vessel before introduction of the co-monomers. Or alternatively, the aqueous medium, or a portion of it, can be added continuously or incrementally during the course of polymerization. The timing and pattern of addition of co-monomers and catalysts, along with polymerization conditions, can be adjusted in conventional manner if desired so as to prepare heterogeneous copolymers.

When emulsion polymerization is used to prepare the co-polymer emulsions, the polymerization can be carried out in the presence of a stabilization system which comprises one or more anionic and/or nonionic surfactants as emulsifiers.

The disclosed process results in a vinyl acetate/diacetoxyethylene copolymer, which contains from 0.05 mole % to 99 mole % of diacetoxyethylene, such as from 1.2 mole % to 5 mole % of diacetoxyethylene, or preferably from 1.4 mole % to 2 mole %, or more preferably greater than or equal to 5 mole % of diacetoxyethylene, such as from 5 mole % to 10 mole % of diacetoxyethylene.

### Polyvinyl Alcohol Formation

Hydrolysis of the polyvinyl ester can be performed using the conventional technique of alcoholysis using an alkali catalyst or acid catalyst, for instance. The hydrolysis reaction in the presence of NaOH as a catalyst with methanol as a solvent is expedient and most preferred among others.

According to one embodiment, the invention is directed to a process, which can be a continuous process, for producing polyvinyl alcohol. The process may comprise the steps of contacting diacetoxyethylene(s) and vinyl acetate to form a vinyl acetate copolymer; and then hydrolyzing the vinyl acetate copolymer to form a co-polymerized polyvinyl alcohol. The resultant polyvinyl alcohol may contain at least 1.2 mole % of 1,2-diol units, e.g., at least 5 mole % 1,2-diol units, or from 1.2 mole % to 5 mole % of 1,2-diol units, or from 1.4 mole % to 10 mole % of 1,2-diol units, or from 1.8 mole % to 20 mole % of 1,2-diol units. Because of the relatively mild polymerization conditions for the vinyl acetate copolymer, the resulting polyvinyl alcohol can have from 0.05 mole % to 99 mole % of 1,2-diol units, enhancing its biodegradeability.

The diacetoxyethylene(s) useful in the process comprise a mixture of trans-diacetoxyethylene and cis-diacetoxyethylene, such as wherein the molar ratio of trans-diacetoxyethylene to cis-diacetoxyethylene is from 1:1 to 4:1, or from 2:1 to 3:1, or from 0.1:1, for example.

In another embodiment, the polyvinyl alcohol contains diol units according to Formula I,

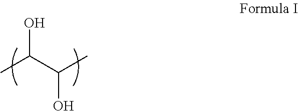

and diol units according to Formula II,

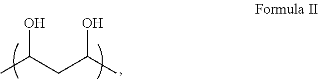

wherein the mole percent of diol units according to Formula I is at least 1.2 mole %, e.g., at least 1.4 mole %, or at least 1.8 mole %, or at least 2 mole %, or from 5 mole % to 10 mole % of the total diol units of said polyvinyl alcohol.

The hydrolysis step may be conducted by contacting the vinyl acetate copolymer with an alcohol in the presence of an alkali or acid catalyst. The hydrolysis may be conducted to a degree of hydrolysis of the polyvinyl alcohol copolymer that may be at least 80%, such as from 80% to 99%, from 90 to 99%, or from 85 to 95%. The resulting polyvinyl alcohol copolymer has a crystallinity that is at least 10% lower than polyvinyl alcohol having only 1,3-diol units at an equivalent degree of hydrolysis, e.g., at least 8% lower or at least 5% lower.

A film containing the polyvinyl alcohol mentioned above in the form of a composition is a preferred embodiment of the present invention. Although a method of producing the film is not particularly limited, a method of forming a film of the inventive copolymer is employed by a method of, for example, casting an aqueous solution of the copolymer or melt extruding it in the presence of a plasticizer, such as glycerol and ethylene glycol, and/or water. Here, the film normally contains 50 weight % or more of the inventive copolymer.

Generally, water-soluble films are transported to, and stored or used in high-temperature, high-humidity regions as well as cold regions and therefore they are required to have strength and toughness, in particular low-temperature impact strength. Therefore, various plasticizers can be used to lower the glass transition temperature of the product films. In accordance with the present invention, a plasticizer can be used for the purpose of improving the solubility in water, in particular, in addition to the purposes mentioned above.

The plasticizer is not particularly restricted but may be any of those generally used as plasticizers for PVA. Thus, it includes, among others, polyhydric alcohols such as glycerol, diglycerol, trimethylolpropane, diethylene glycol, triethylene glycol, dipropylene glycol and propylene glycol; polyethers such as polyethylene glycol and polypropylene glycol; phenol derivatives such as bisphenol A and bisphenol S; amide compounds such as N-methylpyrrolidone; compounds derived from a polyhydric alcohol such as glycerol, pentaerythritol or sorbitol by addition of ethylene oxide; and the like. One or more, e.g., two or more, of these can be used. Among them, glycerol, trimethylolpropane, diethylene glycol, triethylene glycol, dipropylene glycol and propylene glycol are preferred for the purpose of improving the solubility in water of the water-soluble resin composition and of the water-soluble film. Trimethylolpropane is most preferred since it is particularly high in water solubility improving effect.

In one embodiment, the amount of the plasticizer may be 1 to 50 parts by weight based on 100 parts by weight of polyvinyl alcohol. If lower amounts are employed, e.g., the amount is less than 1 part by weight, any substantial effect of incorporation of the plasticizer may not be produced. In some cases, when the amount is more than 50 parts by weight, the plasticizer may bleed out to a significant extent. Hence the resulting films may exhibit lower antiblock properties. From the viewpoint of the rate of dissolution of the resulting films in water, the plasticizer is used preferably in an amount not less than 20 parts by weight. From the viewpoint of the product film stiffness (processability on a bag making machine etc.), it is used preferably in an amount of not more than 40 parts by weight. For the purpose of improving the water solubility of the product films, a relatively high amount of the plasticizer can be used.

While the heat sealing temperature to be employed may vary according to various factors, a relatively high amount of the plasticizer, in particular, allows the use of a lower heat sealing temperature and is thus conducive to improvements in productivity in making films into bags. It is particularly preferred that the amount of the plasticizer be such that the heat sealing temperature for the product films becomes not higher than 170° C., more preferably not higher than 160° C. Furthermore, the amount of the plasticizer significantly influences the Young's modulus of the product films. From the viewpoint of the processability of the product films on a bag making machine or the like, the Young's modulus is preferably at least 1.5 kg/mm², more preferably not less than 2 kg/mm², and the amount of the plasticizer is preferably selected so that films having a Young's modulus falling within such range may be obtained.

In some embodiments, inorganic fillers are incorporated into the PVA composition prior to film-forming. The inorganic filler to be used in the composition of the invention includes, among others, silica, heavy or light or surface-treated calcium carbonate, aluminum hydroxide, aluminum oxide, titanium oxide, diatomaceous earth, barium sulfate, calcium sulfate, zeolite, zinc oxide, silicic acid, silicate salts, mica, magnesium carbonate, kaolin, halloysite, pyrophyllite, sericite and other clay and talc species. These may be used singly or two or more of them may be used in combination. In view of the dispersibility in PVA, in particular, silica is preferably used among others. From the antiblocking viewpoint, the inorganic filler preferably has a particle size of not less than 1 μm and, from the viewpoint of dispersibility in PVA, the particle size is preferably not more than 10 μm. For attaining both of the performance characteristics simultaneously, it is more preferable that the particle size be about 1 to 7 μm.

For the improvement in composition and film water solubility, it is advantageous that the amount of the inorganic filler be 1 to 20 parts by weight based on 100 parts by weight of PVA. Preferably, the amount of the inorganic filler is 3 to 20 parts by weight, more preferably 5 to 20 parts by weight, most preferably 10 to 20 parts by weight. When the inorganic filler is used in the amount of such ranges, films with better antiblocking properties can favorably be obtained.

In the water-soluble resin composition of the invention, there may further be incorporated, where necessary, one or more of conventional additives, such as colorants, perfumes, extenders, antifoaming agents, release agents, ultraviolet absorbers and surfactants, each in an appropriate amount. For improving the releasability of the films formed or film-forming melt or solution from the metal surface of a die or drum of a film-producing machine, in particular, 0.01 to 5 parts by weight of a surfactant is preferably employed based on 100 parts by weight of PVA. Where necessary or appropriate, a PVA resin having a 1,2-glycol linkage content of less than 1.8 mole percent, carboxymethylcellulose, methylcellulose, hydroxymethylcellulose or a like water-soluble polymer may be employed in an amount not weakening the effects of the invention. In particular from the viewpoint of the water solubility improvement, the addition of a low viscosity type of carboxymethylcellulose is preferred.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are hereby incorporated by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

We claim:

1. A process for producing polyvinyl alcohol, the process comprising the steps of:
(a) contacting diacetoxyethylene(s) and vinyl acetate to form a vinyl acetate copolymer; and
(b) hydrolyzing the vinyl acetate copolymer to form a co-polymerized polyvinyl alcohol.

2. The process of claim 1, wherein the polyvinyl alcohol comprises at least 1.4 mole % of 1,2-diol units.

3. The process of claim 2, wherein the polyvinyl alcohol comprises at least 5 mole % of 1,2-diol units.

4. The process of claim 1, wherein the diacetoxyethylene(s) comprise a mixture of trans-diacetoxyethylene and cis-diacetoxyethylene in a molar ratio of trans-diacetoxyethylene to cis-diacetoxyethylene from 1:1 to 4:1.

5. The process of claim 1, wherein the polyvinyl alcohol contains diol units according to Formula I, 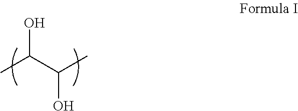
and diol units according to Formula II, 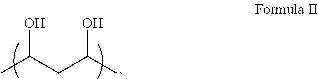
wherein the mole percent of diol units according to Formula I is at least 1.2 mole % of the total diol units of said polyvinyl alcohol.

6. The process of claim 1, wherein said contacting is conducted at a temperature of from 60° C. to 100° C. and at a pressure from atmospheric pressure to less than 0.8 MPa.

7. The process of claim 1, wherein said hydrolysis is conducted by contacting said vinyl acetate copolymer with an alcohol in the presence of an alkali or acid catalyst.

8. The process of claim 1, wherein the degree of hydrolysis of said polyvinyl alcohol copolymer is from 80% to 99%.

9. The process of claim 1, wherein said polyvinyl alcohol copolymer has a crystallinity of about 10% lower than polyvinyl alcohol having only 1,3-diol units at an equivalent degree of hydrolysis.

10. A vinyl acetate/diacetoxyethylene copolymer.

11. The copolymer of claim 10, which comprises from 0.05 mole % to 99 mole % of diacetoxyethylene units.

12. The copolymer of claim 10, which comprises from 1.2 mole % to 5 mole % of diacetoxyethylene units.

13. The copolymer of claim 12, which comprises from 1.4 mole % to 2 mole % of diacetoxyethylene units.

14. The copolymer of claim 10, which comprises at least 5 mole % of diacetoxyethylene units.

15. A process for producing a vinyl acetate copolymer, comprising:
contacting vinyl acetate and diacetoxyethylene(s) in the presence of a polymerization initiator.

16. The process of claim 15, further comprising conducting said contacting at a temperature from 60° C. to 100° C. and at a pressure from atmospheric pressure to less than 0.8 MPa.

17. The process of claim 15, wherein the mole ratio of diacetoxyethylene(s) to vinyl acetate is from 0.01:1 to 0.05:1.

18. The process of claim 15, wherein the diacetoxyethylene(s) comprise a mixture of trans-diacetoxyethylene and cis-diacetoxyethylene in a molar ratio of trans-diacetoxyethylene to cis-diacetoxyethylene from 1:1 to 4:1.

19. A polyvinyl alcohol comprising from 5 mole % up to 99 mole % of 1,2-diol units.

20. A polyvinyl alcohol composition comprising:
polyvinyl alcohol having at least 5 mole % of 1,2-diol units; and
one or more additives selected from the group consisting of plasticizers, fillers, colorants, perfumes, extenders, antifoaming agents, release agents, ultraviolet absorbers and surfactants.
